(19) United States
(12) Patent Application Publication
(10) Pub. No.: US 2024/0026167 A1
(43) Pub. Date: Jan. 25, 2024

(54) SURFACE LAYER, OPTICAL MEMBER, EYEGLASSES AND MATERIAL FOR FORMING SURFACE LAYER

(71) Applicant: CANON OPTRON, INC., Ibaraki (JP)

(72) Inventors: Hiroto NUMAZAWA, Ibaraki (JP); Naoyuki KAWAME, Tochigi (JP)

(21) Appl. No.: 18/477,710

(22) Filed: Sep. 29, 2023

Related U.S. Application Data
(63) Continuation of application No. PCT/JP2021/047347, filed on Dec. 21, 2021.

(30) Foreign Application Priority Data
Jun. 18, 2021 (JP) 2021-101429

(51) Int. Cl. C09D 5/16; C09D 171/00; G02B 1/18; C03C 17/42

(52) U.S. Cl. CPC C09D 5/1637; C09D 171/00; G02B 1/18; C03C 17/42; C03C 2217/76; C03C 2218/151

(57) ABSTRACT

The present invention provides: a surface layer and the like, which achieve a good balance between antifouling characteristics and fixation stability during processing; and a material for forming a surface layer, and the present invention provides a surface layer which contains at least a component A and a component B, wherein: the component A has an organic moiety that contains fluorine; the component B contains an organic moiety that has at least one bond selected from the group consisting of an unsaturated hydrocarbon bond, a carbon-oxygen double bond and a carbon-nitrogen double bond; and the constitutional ratio of the component B to the component A in the surface layer is from 0.15 to 0.80. The present invention also provides a material for forming a surface layer.

### CROSS REFERENCE TO RELATED APPLICATIONS

This application is a Continuation of PCT International Application No. PCT/JP2021/047347, filed on Dec. 21, 2021, which is claiming priority of Japanese Patent Application No. 2021-101429, filed on Jun. 18, 2021, all of which are hereby expressly incorporated by reference into the present application.

### BACKGROUND OF THE INVENTION

### Field of the Invention

The present disclosure relates to a surface layer with excellent processability and antifouling property, an optical member having the surface layer, and eyeglasses having the optical member.

The present disclosure also provides a material for forming a surface layer with excellent processability and antifouling property, a surface layer formed using the material for forming a surface layer, an optical member having the surface layer, and eyeglasses having the optical member.

### Description of the Related Art

Optical members such as antireflection films, optical filters, optical lenses, and lenses for eyeglasses generally have antireflection films made of inorganic materials to suppress the reflection of light. An antireflection film formed of an inorganic material has high surface free energy. Due to the high surface free energy, dirt such as fingerprints, sebum, sweat, and cosmetics often adheres to the surface due to human use. In addition, there is a problem that the adhered dirt is difficult to remove. As a means for solving the problem of adhesion and removal of dirt, Japanese Patent Application Publication No. 2000-144097 and Japanese Patent Application Publication No. 2003-238577 propose to provide the surface of an optical member with a property that makes it difficult for dirt to adhere and facilitates the removal of dirt when such adheres.

However, an optical member having a surface imparted with a property that makes it difficult for dirt to adhere and facilitates the removal of dirt when such adheres (hereinafter, such performance is also referred to as “antifouling property” or “antifouling characteristic”) has a problem that since a frictional force is small and the surface is slippery, the optical member is difficult to fix stably when processing the shape thereof and the processing is difficult.

To resolve this problem, Japanese Patent Application Publication No. 2013-050652 discloses a lens for eyeglasses in which a protective film formed by a coating liquid including a resin made of an organic compound, inorganic oxide fine particles, and an organosilicon compound represented by a predetermined general formula or a hydrolyzate thereof as active components is formed on an oil-repellent coating film, and the composition ratio of the resin made of an organic compound and inorganic oxide fine particles and the content of the organosilicon compound represented by a predetermined general formula or a hydrolyzate thereof are set within predetermined ranges, thereby making it possible to perform edging by a holding method similar to that used for the conventional lenses for eyeglasses even though the oil-repellent coating film is provided.

Further, Japanese Patent Application Publication No. 2005-003817 discloses a lens for eyeglasses in which an antifouling layer is formed on the surface by using two or more kinds of silane compounds, at least one or more kinds of which is a fluorine-containing silane compound, wherein the coefficient of dynamic friction of the lens surface formed by taking each of two or more kinds of silane compounds as a single component is set so that the highest value of the coefficient of the dynamic friction is 1.4 or more times the lowest value of the coefficient of the dynamic friction, thereby making it possible to reduce the slipperiness of the lens surface to the degree enabling edging without decreasing the excellent antifouling effect of the antifouling layer.

### SUMMARY OF THE INVENTION

However, the means for solving the problem that are described in Japanese Patent Application Publication No. 2013-050652 and Japanese Patent Application Publication No. 2005-003817 still cannot be said to be sufficient in terms of fixation during processing, and an antifouling surface that achieves better processing stability and antifouling characteristic is desired.

The present disclosure provides a surface layer that achieves both fixing stability during processing and antifouling characteristic, and an optical member and eyeglasses having the surface layer. In addition, the present disclosure provides a material for forming a surface layer that forms a surface layer that achieves both fixation stability during processing and antifouling characteristic.

A surface layer of the present disclosure is a surface layer comprising at least a component A and a component B, wherein
the component A has an organic segment comprising fluorine,
the component B has an organic segment having at least one bond selected from the group consisting of an unsaturated hydrocarbon bond, a carbon-oxygen double bond and a carbon-nitrogen double bond, and
a composition ratio of component B to component A in the surface layer is from 0.15 to 0.80.

Further, an optical member of the present disclosure is an optical member comprising the above surface layer.

Furthermore, eyeglasses of the present disclosure is eyeglasses comprising the above optical member.

Moreover, a material for forming a surface layer of the present disclosure is a material for forming a surface layer, comprising at least a component A and a component B, wherein
the component A has an organic segment comprising at least fluorine,
the component B has an organic segment having at least one bond selected from the group consisting of an unsaturated hydrocarbon bond, a carbon-oxygen double bond and a carbon-nitrogen double bond, and
the mass ratio of component B to component A in the material for forming the surface layer is from 0.15 to 0.80.

According to the present disclosure, it is possible to provide a surface layer that achieves both fixation stability during processing and antifouling characteristic, and an optical member and eyeglasses having the surface layer. In addition, the present disclosure provides a material for forming a surface layer that forms a surface layer that achieves both fixation stability during processing and antifouling characteristic. Further features of the present invention will become apparent from the following description of exemplary embodiments with reference to the attached drawings.

### BRIEF DESCRIPTION OF THE DRAWINGS

FIG. 1 is a schematic diagram showing the configuration of the surface layer in the first embodiment;

FIG. 2 is a schematic diagram showing the configuration of the surface layer in the second embodiment;

FIG. 3 is a schematic diagram showing the configuration of the optical member in the first embodiment;

FIG. 4 is a schematic diagram showing the configuration of the optical member in the second embodiment; and

FIG. 5 is a schematic diagram showing the configuration of eyeglasses using the optical member in an embodiment.

### DESCRIPTION OF THE EMBODIMENTS

Hereinafter, embodiments of a surface layer according to the present disclosure, an optical member having the surface layer, eyeglasses having the optical member, and a material for forming a surface layer according to the present disclosure will be described with reference to preferred embodiments. Moreover, the present disclosure is not limited to the following embodiments.

In addition, in the present disclosure, unless otherwise specified, the descriptions of “from XX to YY” and “XX to YY” that represent numerical ranges mean numerical ranges that include the lower and upper limits that are endpoints. Furthermore, when a numerical range is described stepwise, the upper limits and lower limits of numerical ranges can be combined arbitrarily.

According to the present disclosure, by maintaining a high frictional force when a high load is applied to a surface layer of a base material or an optical member, it is possible to suppress slipperiness and stably fix the base material or the optical member during processing. In addition, the frictional force is reduced within the range of the load applied to the base material or the surface layer of the optical member when the user uses the base material or the optical member on a daily basis, and the antifouling characteristic can be exhibited. As a result, it is possible to provide a surface layer that achieves both processability and antifouling characteristic, an optical member having the surface layer, and eyeglasses having the optical member. Further, it is possible to provide a material for forming a surface layer that imparts the above characteristics to the surface layer.

The inventors consider as follows the mechanism by which the surface layer according to the present disclosure and the optical member having the surface layer achieve both stability during processing and antifouling characteristic.

A compound having an organic segment comprising fluorine is selected as component A comprised in the surface layer. A compound having an organic segment having at least one bond selected from the group consisting of an unsaturated hydrocarbon bond, a carbon-oxygen double bond and a carbon-nitrogen double bond is selected as component B.

Since component A has an organic segment comprising fluorine, the antifouling characteristic is exhibited, but a frictional force tends to be low when a load is applied. In addition, since component B has an organic segment having at least one bond selected from the group consisting of an unsaturated hydrocarbon bond, a carbon-oxygen double bond and a carbon-nitrogen double bond, this component is less likely to deform, even when a load is applied, as compared with component A, and the frictional force tends to be high.

Therefore, when a surface layer comprising at least components A and B contacts an object, component B is less likely to deform than component A when a high load is applied, and because the proportion of component B in contact with the object that is in contact with the surface layer is increased, a high frictional force can be obtained.

In addition, by adjusting the composition ratio of component B to component A in the surface layer within a predetermined range, high antifouling characteristic can be obtained when the surface layer and the object come into contact with each other under a low load.

The “surface layer” herein refers to the interface in contact with the base material and in contact with solid, liquid or gas. That is, in the present description, the “surface layer” is the surface of the base material, and the present description also discloses the base material having this surface.

As the base material, any material can be adopted as long as the material is solid and an underlayer 12, a surface layer 13, an intermediate layer 14, or a hard coat layer 15, which will be described hereinbelow, can be formed, but the base material is preferably glass, ceramic, resin, or metal, or a film made of glass, resin, or the like.

The optical member is an optical member comprising a base material having the surface layer. Examples of the optical member include optical filters, optical lenses, lenses for eyeglasses, photographic lenses, cover glasses for displays, touch panels for displays and various films.

The eyeglasses are eyeglasses having the above optical member. The eyeglasses are inclusive of general equipment to be worn around the eyes, and are not limited to usual vision correction eyeglasses, but include stylish eyeglasses, protective goggles, head-mounted displays, sunglasses, smart glasses, and the like.

Component A according to the present disclosure will be explained hereinbelow.

Component A has an organic segment comprising fluorine. The organic segment comprising fluorine is preferably at least one segment selected from the group consisting of a fluoroalkyl segment, a fluoroalkyl ether segment, a fluoropolyether segment, a vinylidene fluoride segment and a perfluoropolyether segment. More preferably, component A has a perfluoropolyether segment.

Specifically, for example, component A is a compound having a structure represented by the following general formula:

R₁—X—R₂ (1)

and is preferably a perfluoroalkyl compound.

Here, the “organic segment comprising fluorine” means the segment represented by X and the segment represented by R₂ in the general formula (1) when component A is a compound having a structure represented by the general formula (1).

In a preferred embodiment, the segment represented by X in formula (1) consists of any combination of at least one segment selected from the segments shown in Table 1 below. Further, when the segment represented by R₂ does not comprise fluorine, the segment represented by X comprises fluorine.

TABLE 1

| | | |
|---|---|---|
| [CₙH₂ₙ]ₘ₁ | [CₙF₂ₙ]ₘ₂ | [CₙHₙFₙ]ₘ₃ |
| [CₙH₂ₙ]ₘ₄O | [CₙF₂ₙ]ₘ₅O | [CₙHₙFₙ]ₘ₆O |
| [CₙH₂ₙO]ₘ₇ | [CₙF₂ₙO]ₘ₈ | [CₙHₙFₙO]ₘ₉ |
| [CₙH₂ₙOₙ]ₘ₁₀ | [CₙF₂ₙOₙ]ₘ₁₁ | [CₙHₙFₙOₙ]ₘ₁₂O |
| [C₆H₄]ₘ₁₃ | [CH₃]ₘ₁₄ | O[CH₃]ₘ₁₅ |
| | [CF₃]ₘ₁₆ | O[CF₃]ₘ₁₇ |

In Table 1, n, m₁, m₂, m₃, m₄, m₅, m₆, m₇, m₈, m₉, m₁₀, m₁₁, m₁₂, m₁₃, m₁₄, m₁₅, m₁₆, and m₁₇ preferably satisfy 15≤n×(m₁+m₂+m₃+m₄+m₅+m₆+m₇+m₈+m₉+m₁₀+m₁₁+m₁₂+m₁₃+m₁₄+m₁₅+m₁₆+m₁₇)≤200. A more preferable range of n×(m₁+m₂+m₃+m₄+m₅+m₆+m₇+m₈+m₉+m₁₀+m₁₁+m₁₂+m₁₃+m₁₄+m₁₅+m₁₆+m₁₇) is 16≤n×(m₁+m₂+m₃+m₄+m₅+m₆+m₇+m₈+m₉+m₁₀+m₁₁+m₁₂+m₁₃+m₁₄+m₁₅+m₁₆+m₁₇)≤200, an even more preferable range is 30≤n×(m₁+m₂+m₃+m₄+m₅+m₆+m₇+m₈+m₉+m₁₀+m₁₁+m₁₂+m₁₃+m₁₄+m₁₅+m₁₆+m₁₇)≤150, and a particularly preferable range is 40≤n×(m₁+m₂+m₃+m₄+m₅+m₆+m₇+m₈+m₉+m₁₀+m₁₁+m₁₂+m₁₃+m₁₄+m₁₅+m₁₆+m₁₇)≤120.

In Table 1, m₁, m₂, m₃, m₄, m₅, m₆, m₇, m₈, m₉, m₁₀, m₁₁, m₁₂, m₁₃, m₁₄, m₁₅, m₁₆, and m₁₇ are each independently an integer of 0 or more. That is, m₁, m₂, m₃, m₄, m₅, m₆, m₇, m₈, m₉, m₁₀, m₁₁, m₁₂, m₁₃, m₁₄, m₁₅, m₁₆, and m₁₇ in Table 1 may be different values for each segment.

Here, when m₁, m₂, m₃, m₄, m₅, m₆, m₇, m₈, m₉, m₁₀, m₁₁, m₁₂, m₁₃, m₁₄, m₁₅, m₁₆, and m₁₇ are 0, it indicates that none of the segments described in Table 1 is included in the segment represented by X in formula (1). In addition, O in Table 1 represents oxygen that forms an ether bond.

Each n in Table 1 is independently an integer of 1 or more, preferably 2 or more. Also, n is preferably 6 or less, more preferably 3 or less. For example, n can independently be from 1 to 6 for each segment. That is, n in Table 1 may be a different value for each segment.

The segment represented by X may branch in the middle of the molecular chain, and a side chain containing a segment shown in Table 1 may be present, as long as the range of n×(m₁+m₂+m₃+m₄+m₅+m₆+m₇+m₈+m₉+m₁₀+m₁₁+m₁₂+m₁₃+m₁₄+m₁₅+m₁₆+m₁₇) is satisfied.

R₁ in the general formula (1) is preferably an organic group containing a hydrolyzable group, a silanol group, or a hydrolyzable group-containing silyl group. Examples of hydrolyzable groups include alkoxy groups having from 1 to 10 carbon atoms, such as a methoxy group, an ethoxy group, a propoxy group, a butoxy group, and the like, alkoxyalkoxy groups having from 2 to 10 carbon atoms, such as a methoxymethoxy group, a methoxyethoxy group, and the like, acyloxy groups having from 1 to 10 carbon atoms, such as an acetoxy group and the like, alkenyloxy groups having from 2 to 10 carbon atoms such as an isopropenoxy group, halogen groups such as a chloro group, a bromo group, a iodo group, and the like, amino groups, and the like. Among them, a methoxy group, an ethoxy group, an isopropenoxy group and a chloro group are preferable. The number of hydrolyzable groups in the organic group containing a hydrolyzable group-containing silyl group is preferably from 1 to 3, more preferably 2 or 3, still more preferably 3.

R₂ in the general formula (1) is not particularly limited, but when the segment represented by X does not comprise fluorine, the segment represented by R₂ comprises fluorine. R₂ is preferably a hydrogen- or fluorine-terminated alkyl segment or alkyl ether segment. A fluoroalkyl group or a fluoroalkyl ether group is more preferred, and a perfluoroalkyl group or a perfluoroalkyl ether group is even more preferred. The number of carbon atoms in the alkyl segment, the alkyl ether segment, the fluoroalkyl group, the fluoroalkyl ether group, the perfluoroalkyl group and the perfluoroalkyl ether group is preferably from 1 to 3, more preferably 1 or 2.

Specific examples of component A include the compounds shown in Table 2 but are not limited to these compounds.

Also, as component A, a compound having an organic segment comprising fluorine may be used singly or in combination of two or more.

TABLE 2

| No. | Structure | No. | Structure |
|---|---|---|---|
| A-1 | (EtO)₃—Si—[CH₂]₁₅—CF₃ | B-22 | (MeO)₃—Si—[C₃H₆—O]₃₂—CF₃ |
| A-2 | (MeO)₃—Si—[CF₂]₁₅—CF₃ | B-23 | (MeO)₃—Si—[C₂H₄—O]₄₈—CF₃ |
| B-1 | (MeO)₃—Si—[C₃H₆]₆—[CF₂—O]—[C₂F₄—O]—[C₃F₆—O]₂—CF₃ | B-24 | (MeO)₃—Si—[CH₂—O]₉₆—CF₃ |
| B-2 | (MeO)₃—Si—[CH₂]₃—[C₃F₆—O]₄—CF₃ | B-25 | (MeO)₃—Si—[C₆H₁₂—O]₈—[C₅F₁₂—O]₈—CF₃ |
| B-3 | (MeO)₃—Si—[CH₂]₃—[O—CH₂]—[OCF₂]₂—[OC₂F₄]— | B-26 | (MeO)₃—Si—[C₄H₈—O]₁₂—[C₄F₈—O]₁₂—CF₃ |
| | [OC₃F₆]₂—OCF₃ | | |
| B-4 | (MeO)₃—Si—[C₅H₁₀—O]₃—CF₃ | B-27 | (MeO)₃—Si—[C₃H₆—O]₁₆—[C₃F₆—O]₁₆—CF₃ |
| B-5 | (MeO)₃—Si—[C₃H₆—O]₅—CF₃ | B-28 | (MeO)₃—Si—[C₂H₄—O]₂₄—[C₂F₄—O]₂₄—CF₃ |
| B-6 | (MeO)₃—Si—[CH₂—O]₁₅—CF₃ | B-29 | MeO—[CH₂—O]₄₈—[CF₂—O]₄₈—CF₃ |
| B-7 | MeO—[C₃H₆—O]₂—[C₃F₆—O]₃—CF₃ | B-30 | (MeO)₃—Si—[C₆F₁₂—O]₁₅—CF₃ |
| B-8 | MeO—[CH₂—O]₇—[CF₂—O]₈—CF₃ | B-31 | (MeO)₃—Si—[CH₂]₆—[C₃F₆—O]₃₀—CF₃ |
| B-9 | (MeO)₃—Si—[C₅F₁₀—O]₃—CF₃ | B-32 | (MeO)₃—Si—[C₄F₈—O]₂₄—CF₃ |
| B-10 | (MeO)₃—Si—[C₃H₆—O]₅—CF₃ | B-33 | (HO)₃—Si—[CH₂]₆—O—[CH₂—CF₂]₂—[CF₂]₆— |
| | | | [C₂F₄]₁₀—[C₃F₆]₂₀—CF₃ |
| B-11 | (MeO)₃—Si—[CF₂—O]₁₅—CF₃ | B-34 | (MeO)₃—Si—[C₃F₆—O]₃₂—CF₃ |
| A-3 | (EtO)₃—Si—[C₂H₄]₆—[CH₂—CF₂]₁₆—CF₃ | B-35 | (MeO)₃—Si—[CH₂]₃—[O—CH₂]—[CF₂—O]₁₂— |
| | | | [C₂F₄—O]₁₀—[C₃F₆—O]₂₀—CF₃ |
| A-4 | (MeO)₃—Si—[CF₂]₄₄—CF₃ | B-36 | MeO—[C₂F₄—O]₄₈—CF₃ |
| B-12 | (MeO)₃—Si—[C₄H₈—O]₁₁—CF₃ | C-2 | EtO—[CH₂—CF₂]₄₈—CF₃ |
| B-13 | (MeO)₃—Si—[CH₂—O]₄₄—CF₃ | A-8 | (MeO)₃—Si—[CH₂]₁₇₈—CF₃ |
| B-14 | (MeO)₃—Si—[C₄H₈—O]₅—[C₄F₈—O]₆—CF₃ | A-9 | MeO—[CH₂]₈₉—[CF₂]₈₉—CF₃ |
| B-15 | (MeO)₃—Si—[C₃H₆]₆—[CF₂—O]₂—[C₂F₄—O]₃— | A-10 | (MeO)₃—Si—[CF₂]₁₇₈—CF₃ |
| | [C₃F₆—O]₆—CF₃ | | |
| B-16 | (MeO)₃—Si—[CH₂]₈—[C₃F₆—O]₁₂—CF₃ | B-37 | (MeO)₃—Si—[C₂H₄—O]₈₉—CF₃ |
| B-17 | MeO—[CH₂—O]₂₂—[CF₂—O]₂₂—CF₃ | B-38 | (MeO)₃—Si—[C₂H₄]₂₅—[CH₂—CF₂]₅₄—CF₃ |
| B-18 | (MeO)₃—Si—[C₄F₈—O]₁₁—CF₃ | B-39 | (MeO)₃—Si—[CH₂—O]₁₇₈—CF₃ |
| B-19 | (MeO)₃—Si—[CH₂]₃—[O—CH₂]—[OCF₂]₈— | B-40 | (MeO)₃—Si—[C₂H₄—O]₄₄—[C₂F₄—O]₄₅—CF₃ |
| | [OC₂F₄]₇—[OC₃F₆]₆—OCF₃ | | |
| C-1 | MeO—[CH₂—CF₂]₂₂—CF₃ | B-41 | MeO—[CH₂—O]₈₉—[CF₂—O]₈₉—CF₃ |
| D-1 | (MeO)₃—Si—[CH₂]₄₄—OCF₃ | B-42 | (MeO)₃—Si—[CH₂]₇—[C₃F₅—O]₆₇—CF₃ |
| A-5 | (MeO)₃—Si—[CH₂]₉₆—CF₃ | B-43 | (MeO)₃—Si—[CH₂]₃—[O—CH₂]—[CF₂—O]₄— |
| | | | [C₂F₄—O]₂₅—[C₃F₆—O]₄₀—CF₃ |
| A-6 | (MeO)₃—Si—[C₂H₄]₆—[CH₂—CF₂]₁₅—CF₃ | B-44 | MeO—[C₂F₄—O]₈₉—CF₃ |
| A-7 | (MeO)₃—Si—[CF₂]₉₈—CF₃ | B-45 | (MeO)₃—Si—[CF₂—O]₁₇₈—CF₃ |
| B-20 | (MeO)₃—Si—[C₅H₁₂—O]₁₆—CF₃ | C-3 | EtO—[CH₂—CF₂]₈₉—CF₃ |
| B-21 | (MeO)₃—Si—[C₄H₈—O]₂₄—CF₃ | | |

In the table, Me represents a methyl group and Et represents an ethyl group.

Component B according to the present disclosure will be explained hereinbelow.

Component B has an organic segment having at least one bond selected from the group consisting of an unsaturated hydrocarbon bond, a carbon-oxygen double bond and a carbon-nitrogen double bond. Preferably, component B has an organic segment having an unsaturated hydrocarbon bond, and the unsaturated hydrocarbon bond is derived from at least one compound selected from the group consisting of 1,2-polybutadiene, 1,4-polybutadiene, 1,2-polyisoprene, 1,4-polyisoprene, 1,2-polychloroprene, and 1,4-polychloroprene. More preferably, the unsaturated hydrocarbon bond is derived from at least one compound selected from the group consisting of 1,2-polybutadiene and 1,2-polyisoprene.

In addition, an embodiment is also preferred in which component B has a polyolefin having, in a side chain, an organic segment having at least one bond selected from the group consisting of an unsaturated hydrocarbon bond, a carbon-oxygen double bond, and a carbon-nitrogen double bond.

Specifically, component B is, for example, an alkyl compound having a structure represented by the following general formula:

R₃—Y—R₄ (2)

Here, “an organic segment having at least one bond selected from the group consisting of an unsaturated hydrocarbon bond, a carbon-oxygen double bond and a carbon-nitrogen double bond” means a segment represented by Y in the general formula (2) when component B is a compound having the structure represented by the general formula (2).

The segment represented by Y in the general formula (2) has one or more segments having at least one bond selected from the group consisting of an unsaturated hydrocarbon bond, a carbon-oxygen double bond and a carbon-nitrogen double bond shown in Table 3. Further, among the unsaturated hydrocarbon bond, carbon-oxygen double bond and carbon-nitrogen double bond, one or two or more bonds of only any one kind may be present or bonds of two or more kinds may be present in combination. Further, among the segments shown in Table 3, segments having no unsaturated hydrocarbon bond may be further used in combination.

TABLE 3

| | |
|---|---|
| [CᵢH₂ᵢ₋₂]ⱼ₁ | [CᵢHᵢFᵢ]ⱼ₂ |
| [CᵢH₂ᵢ]ⱼ₃ | [CᵢH₃ᵢ]ⱼ₄ |
| [C₆H₄]ⱼ₅ | |

In Table 3, i and j₁, j₂, j₃, j₄ and j₅ preferably satisfy 32≤i×(j₁+j₂+j₃+j₄+j₅)≤180, more preferably 40≤i×(j₁+j₂+j₃+j₄+j₅)≤150, and even more preferably, 50≤i×(j₁+j₂+j₃+j₄+j₅)≤120.

In Table 3, i is each independently an integer of 1 or more, and may be a different value for each segment.

In Table 3, j₁, j₂, j₃, j₄ and j₅ are each independently an integer of 0 or more. That is, j₁, j₂, j₃, j₄, and j₅ in Table 3 may have different values for each segment.

Here, when j₁, j₂, j₃, j₄, and j₅ are 0, it indicates that none of the segments described in Table 3 is included in the segment represented by Y in formula (2).

The segment represented by Y may be branched in the middle of the molecular chain, and a side chain consisting of a segment having at least one bond selected from the group consisting of an unsaturated hydrocarbon bond, a carbon-oxygen double bond and a carbon-nitrogen double bonds may be present, provided that the range of i×(j₁+j₂+j₃+j₄+j₅) is satisfied.

In the preferred structure of component B, any one of unsaturated hydrocarbon bond, carbon-oxygen double bond and carbon-nitrogen double bond, or any combination thereof is present in the side chain. More preferably, an unsaturated hydrocarbon bond or a carbon-oxygen double bond, or any combination thereof is present in the side chain.

R₃ and R₄ in the general formula (2) may each independently be a reactive group or a hydrogen atom. The reactive group is preferably a hydrolyzable silyl group or a hydroxyl group, more preferably a hydroxyl group.

Specific examples of component B include the compounds shown in Table 4 but are not limited to these compounds. In addition, as component B, one kind of compound including one or more segments including at least one bond selected from the group consisting of an unsaturated hydrocarbon bond, a carbon-oxygen double bond and a carbon-nitrogen double bond may be used or two or more kinds may be used in combination.

TABLE 4

| No. | Structure |
|---|---|
| a-1 | H—[C₄H₆]₈—H |
| a-2 | HO—[CH₂]₂—[CH₂—CH═CH—CH₂]₈—[CH₂]₂—OH |
| a-3 | H—[CH₂—CH═CH—CH₂]₂₂—H |
| a-4 | 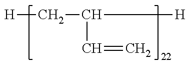 |
| a-5 | HO—[CH₂]₂—[CH₂—CH═CH—CH₂]₂₄—[CH₂]₂—OH |
| a-6 | 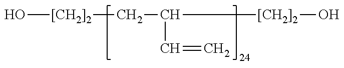 |
| a-7 | HO—[CH₂]₂—[CH₂—CH═CH—CH₂]₃₄—[CH₂]₂—OH |
| a-8 | 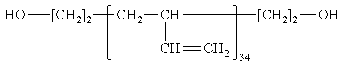 |
| a-9 | H—[CH₂—CH═CH—CH₂]₄₀—H |
| a-10 | 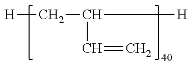 |
| a-11 | HO—[CH₂]₂—[CH₂—CH═CH—CH₂]₅₄—[CH₂]₂—OH |
| a-12 | 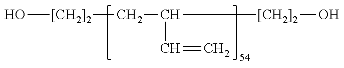 |
| a-13 | 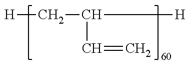 |
| a-14 | H—[CH₂—CH═CH—CH₂]₁₄₀—H |
| b-1 | 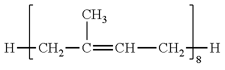 |
| b-2 | 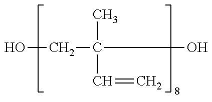 |
| b-3 | 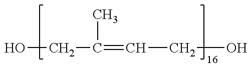 |
| b-4 | 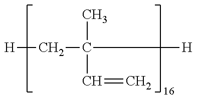 |
| b-5 | 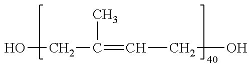 |
| b-6 | 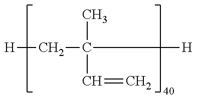 |
| c-1 | 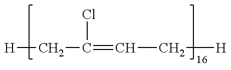 |
| c-2 | 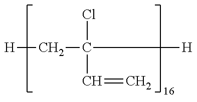 |

Specific examples of component B include the compounds shown in Table 5 but are not limited to these compounds.

TABLE 5

| No. | Structure |
|---|---|
| d-1 | 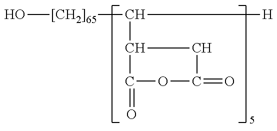 |
| d-2 | 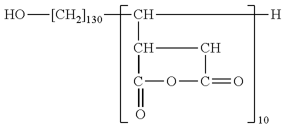 |
| d-3 | 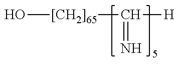 |
| d-4 | 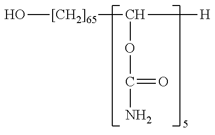 |

The compounds shown in Table 5 are modified polyolefins in which part of the side chain is replaced with an alkyl segment having any of an unsaturated hydrocarbon bond, a carbon-oxygen double bond, and a carbon-nitrogen double bond. The imino segment, vinyl segment, carboxylic acid segment, ketene segment, isocyanate segment, and the like can be presented as examples of segments to be replaced.

The composition ratio of component B to component A in the surface layer of the present disclosure can be represented by P_{B}/P_{A} where P_{A} stands for a peak intensity derived from component A and P_{B} stands for a peak intensity derived from component B when the surface layer is measured with a micro-Raman spectrometer, and the composition ratio can be in the range of from 0.15 to 0.80.

Further, the composition ratio of component B to component A in the surface layer of the present disclosure can be adjusted by the mass ratio of component B to component A in the material for forming a surface layer of the present disclosure. The composition ratio is preferably from 0.20 to 0.60, more preferably from 0.20 to 0.50.

Where the composition ratio of component B to component A is less than 0.15, even though the antifouling characteristic is exhibited, the frictional force when a high load is applied during processing does not increase and the slipperiness is not suppressed, so that it becomes difficult to process the base material. In addition, where the composition ratio of component B to component A is greater than 0.80, the frictional force becomes high even in the range of loads that the user uses on a daily basis, and not only does the antifouling characteristic decrease, but there are also problems with ease of use, such as the cloth getting caught when wiping off the dirt.

The composition ratio of component B to component A can be obtained by the following method.

First, a region of the surface layer to be measured by the micro-Raman spectrometer is determined. The region is determined by the magnification of an objective lens attached to the device, the wavelength of an excitation laser, and the aperture diameter. Hereinafter, the determined region will also be referred to as a “measurement region”.

Next, the measurement region is irradiated with excitation laser light and the scattered light generated is measured to obtain a Raman spectrum. The measurement conditions are as follows.
Measurement device: micro-Raman spectrometer manufactured by Thermo Fisher Scientific, Inc.
Objective lens magnification: 10×
Excitation laser wavelength: 532 nm
Aperture diameter: 25 μm
Measurement region: 2 μm

Among the peaks in the obtained Raman spectrum, the peak derived from the C—F bond is defined as the peak derived from component A, and the peak intensity of the peak is defined as P_{A}. Further, among the peaks in the obtained Raman spectrum, the peak derived from the C═C bond, C═O bond or C═N bond is defined as the peak derived from component B, and the peak intensity of the peak is defined as P_{B}.

When the load applied to the surface layer is 14 kgf, the frictional force measured at a friction speed of 2.5 mm/sec is denoted by X,
when the load applied to the surface layer is 70 kgf, the frictional force measured at a friction speed of 2.5 mm/sec is denoted by Y,
the rate of change of the frictional force represented by (Y−X)/X×100 is preferably from 50% to 700%, more preferably from 95% to 680%.

The rate of change can be controlled by the type of component A, the type of component B, and the composition ratio of component B to component A.

The surface layer of the present disclosure may include any compound other than component A and component B within a range that does not impair the effects of the present disclosure.

### First Embodiment

FIG. 1 is a schematic diagram showing the configuration of the surface layer in the first embodiment, this figure showing a configuration example in which an underlayer is formed on a base material and a surface layer is formed on the underlayer.

In the configuration shown in FIG. 1, the underlayer 12 is present on the base material 11, and the surface layer 13 is formed on the underlayer 12.

FIG. 1 shows the configuration having the surface layer in a simulated manner and does not represent the actual thicknesses of the base material 11, the underlayer 12 and the surface layer 13 in exact proportions.

Base Material 11

The base material 11 may be any material as long as the material is solid and the underlayer 12, the surface layer 13, or the below-described intermediate layer 14 or hard coat layer 15 can be formed, and examples thereof include glass, ceramic, resin, or metal, or a film made of glass, resin, or the like. Where the above materials are used as the base material of the optical member having the surface layer of the present disclosure, the base material is preferably capable of transmitting visible light or light of a specific wavelength.

The thickness of the base material is not particularly limited and can be set as appropriate according to the application.

Underlayer 12

The underlayer may be formed as necessary. The underlayer 12 is a layer serving as a base for forming the surface layer 13 and improves the adhesion between the base material 11 and the surface layer 13.

In this embodiment, in order to further improve the adhesion between the base material 11 and the surface layer 13, the underlayer 12 is formed on the base material 11, and the surface layer 13 is formed on the underlayer 12. A method for forming the underlayer is not particularly limited, and examples thereof include a vapor deposition method, a dipping method, a coating method, a spray method, a spin coating method, and the like.

Although the thickness of the underlayer 12 is not particularly limited, it is from 2 nm to 150 nm, preferably from 5 nm to 125 nm.

The material forming the underlayer 12 is preferably a substance having hydroxyl groups on the surface. Examples thereof include metal oxides such as SiO₂ and Al₂O₃ having hydroxyl groups on the surfaces, and alkyl compounds having hydroxyl groups.

Surface Layer 13

The surface layer 13 is the surface layer of the present disclosure described above.

Although the thickness of the surface layer 13 is not particularly limited, it is preferably from 4 nm to 20 nm. When the thickness is 4 nm or more, sufficient antifouling property is obtained, and when the thickness is 20 nm or less, the transparency is good.

### Second Embodiment

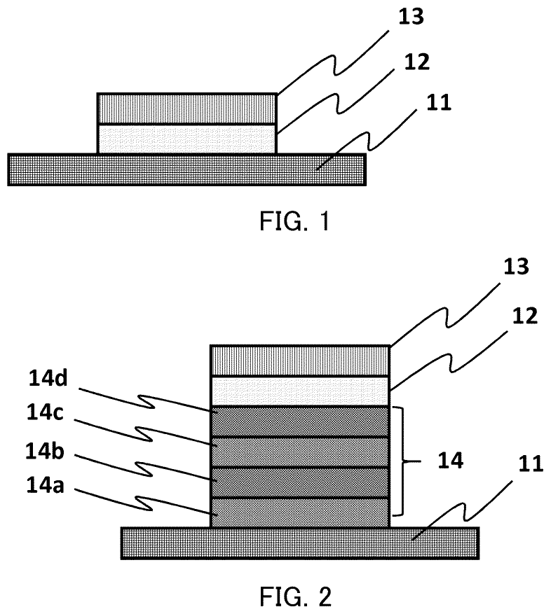

FIG. 2 is a schematic diagram showing the structure of the surface layer in the second embodiment, this figure showing a configuration example in which an intermediate layer is formed on the base material, an underlayer is formed on the intermediate layer, and a surface layer is formed on the underlayer.

In FIG. 2, the intermediate layer 14 is formed on the base material 11 by alternately laminating intermediate layers 14a and 14c having a low-refractive-index material and intermediate layers 14b and 14d having a high-refractive-index material. The surface layer 13 is formed on the underlayer 12 provided on the intermediate layer 14.

FIG. 2 shows the configuration having the surface layer in a simulated manner and does not represent the actual thicknesses of the base material 11, the intermediate layer 14, the underlayer 12 and the surface layer 13 in exact proportions.

Intermediate Layer 14

As shown in FIG. 2, in the intermediate layer 14, odd-numbered laminated intermediate layers 14a and 14c counted from the base material 11 side are made of a low-refractive-index material, and even-numbered laminated intermediate layers 14b and 14d are made of a high-refractive-index material.

In this embodiment, the underlayer 12 is also made of a low-refractive-index material, is laminated on the intermediate layer 14, and exhibits an antireflection function together with the intermediate layer 14. In this embodiment, as an example, the intermediate layer 14 is configured of four layers, and the underlayer 12 is formed on the intermediate layer 14d having a high-refractive-index material, so the underlayer 12 is preferably made of a low-refractive-index material. For example, when the intermediate layer 14 is configured of two layers and the underlayer 12 is formed on the intermediate layer 14b having a high-refractive-index material, the underlayer 12 is preferably made of a low-refractive-index material.

Also, the intermediate layer 14 is not limited to the present embodiment, and may be obtained by laminating, as appropriate, layers made of medium-refractive-index materials.

Examples of low-refractive-index materials include SiO₂ (silicon dioxide), Al₂O₃-added SiO₂ (alumina-added silicon dioxide), and the like. However, the low-refractive-index material is not limited to these.

Examples of high-refractive-index materials include alumina-containing titanium oxide-lanthanum oxide mixed materials, titanium oxide, other mixed oxides containing titanium oxide as a main component, zirconium oxide, mixed materials containing zirconium oxide as a main component, mixed materials containing niobium oxide as a main component, tantalum oxide, mixed materials containing tantalum oxide as a main component, tungsten oxide, mixed materials containing tungsten oxide as a main component, and the like. However, the high-refractive-index material is not limited to these.

Examples of medium-refractive-materials include aluminum oxide, other mixed compounds containing aluminum oxide as a main component, magnesium oxide, other mixed compounds containing magnesium oxide as a main component, yttrium fluoride, cerium fluoride, and the like. However, the medium-refractive-index material is not limited to these.

The thickness of the intermediate layer 14 and the layers constituting the intermediate layer 14 (14a, 14b, 14c, 14d in FIG. 2) is not particularly limited, but for example, the thickness of each layer constituting the intermediate layer 14 is from 10 nm to 200 nm, and the intermediate layer 14 can be constructed by laminating a required number of layers.

Although the intermediate layer 14 in this embodiment has a four-layer structure, the present disclosure is not limited to this, and the number of layers may be any number.

Further, in the present embodiment, as described above, the intermediate layer 14 is provided as a part of the antireflection film formed by alternately laminating the low-refractive-index layers and the high-refractive-index layer, but the present disclosure is not limited to this configuration. For example, at least one layer having a function selected from those of other filters, mirrors, antistatic, anti-scratch hard coats, etc. may be formed between the base material 11 and the intermediate layer 14.

The base material, underlayer and surface layer in the second embodiment of the surface layer can be the same as those in the first embodiment of the surface layer.

Optical Member

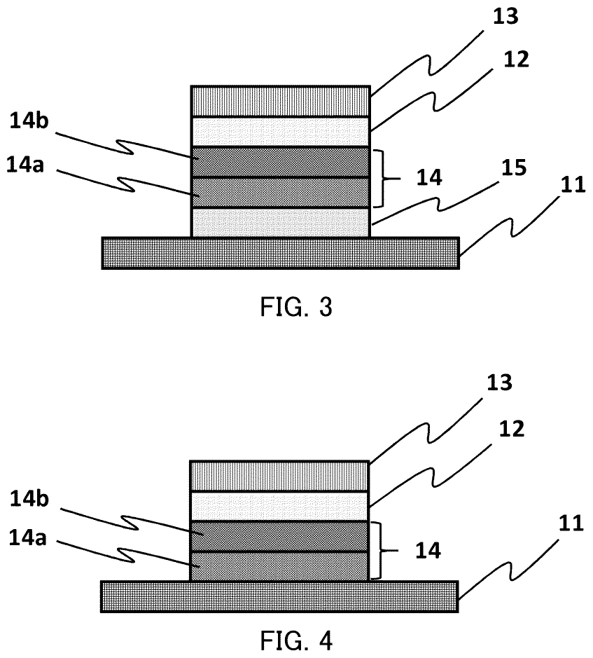

FIG. 3 is a schematic diagram showing the configuration of the optical member in the first embodiment.

This embodiment is an optical member that can be used for lenses for eyeglasses.

In the optical member shown in FIG. 3, the base material 11 made of resin, the hard coat layer 15 for preventing scratches, the intermediate layer 14 having an antireflection function as described in the second embodiment of the surface layer, the underlayer 12, and the surface layer 13 are provided. In FIG. 3, the intermediate layer 14 has a two-layer configuration in which odd-numbered laminated intermediate layers 14a counted from the base material 11 side are made of a low-refractive-index material, and even-numbered laminated intermediate layers 14b are made of a high-refractive-index material, but such a configuration is not limiting, and the number of layers may be any number. Also, layers made of medium-refractive-index materials may be laminated, as appropriate.

As the hard coat layer 15, for example, melamine resin, urethane resin, acrylic resin, a mixture of the above resins, a silane compound, or the like can be used. However, the material suitable for the hard coat layer is not limited to these.

The optical member shown in the configuration of the first embodiment is not limited to lenses for eyeglasses and can be used for other known applications.

FIG. 4 is a schematic diagram showing the configuration of the optical member in the second embodiment.

This embodiment is an optical member that can be used for an optical lens to be used in a camera or the like.

The optical member shown in FIG. 4 is provided with the base material 11 made of glass, the intermediate layer 14 having an antireflection function as described in the second embodiment of the surface layer, the underlayer 12, and the surface layer 13. In FIG. 4, the intermediate layer 14 has a two-layer configuration in which odd-numbered laminated intermediate layers 14a counted from the base material 11 side are made of a low-refractive-index material, and even-numbered laminated intermediate layers 14b are made of a high-refractive-index material, but such a configuration is not limiting, and the number of layers may be any number. Also, layers made of medium-refractive-index materials may be laminated, as appropriate.

The optical member shown in the configuration of the second embodiment is not limited to those used for optical lenses for cameras, and can also be used for optical filters, touch panels for displays, various films, and the like.

Eyeglasses

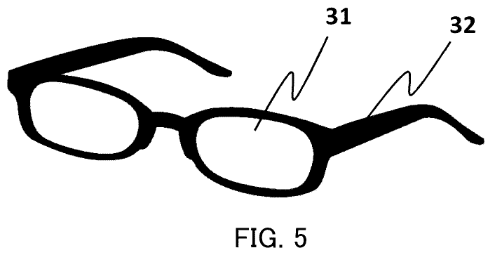

FIG. 5 is a schematic diagram showing the configuration of eyeglasses in one embodiment, the eyeglasses using the optical member of the present disclosure.

This embodiment is configured of a lens 31 for eyeglasses, which is the above-described optical member of the present disclosure, and a frame 32 for eyeglasses.

The material for forming a surface layer of the present disclosure comprises at least component A and component B, wherein
the component A has an organic segment comprising at least fluorine,
the component B has an organic segment having at least one bond selected from the group consisting of an unsaturated hydrocarbon bond, a carbon-oxygen double bond and a carbon-nitrogen double bond, and
the mass ratio of component B to component A in the material for forming a surface layer is from 0.15 to 0.80.

The material for forming a surface layer according to the present disclosure will be described hereinbelow.

Components A and B constituting the material for forming a surface layer of the present disclosure are the same as components A and B constituting the surface layer of the present disclosure.

As for the mass ratio of component A to component B in the material for forming a surface layer of the present disclosure, where the mass of component A is taken as 1, the mass of component B is in the range of from 0.15 to 0.80. That is, the mass ratio of component B to component A in the material for forming a surface layer is from 0.15 to 0.80. The mass ratio is preferably from 0.20 to 0.60, more preferably from 0.20 to 0.50.

Where the mass ratio of component B to component A is less than 0.15, even though the surface layer formed using the material for forming a surface layer exhibits antifouling characteristic, the frictional force when a high load is applied during processing of the base material or optical member having the surface layer does not increase and the slipperiness is not suppressed, so that it becomes difficult to process the base material or optical member. In addition, where the mass ratio of component B to component A is greater than 0.80, the frictional force becomes high even in the range of loads that the user uses on a daily basis, and not only does the antifouling characteristic of the surface layer formed using the material for forming a surface layer decrease, but there are also problems with ease of use, such as the cloth getting caught when wiping off the dirt.

The mass ratio of component B to component A in the material for forming a surface layer can be determined using liquid chromatography mass spectrometry. Alternatively, it is also possible to obtain this ratio by using the values of the mass of component A and the mass of component B weighed with a balance when producing the material for forming a surface layer.

### EXAMPLES

The present disclosure will be described more specifically hereinbelow with reference to examples, but the present disclosure is not limited to the following examples.

### Example 1

### Preparation of Material for Forming Surface Layer

The compound (B-19) listed in Table 2 as component A and the compound (a-4) listed in Table 4 as component B were compounded in a metal container so that the mass ratio of component B to component A was 0.20 to obtain a material 1 for forming a surface layer.

Preparation of Underlayer

The underlayer 12 made of SiO₂ with a thickness of 10 nm was formed by vapor deposition using a vacuum deposition apparatus (dome diameter 1900 mm, deposition distance 890 mm) on a borosilicate glass with a thickness of 3 mm, which was the base material 11. The thickness of the underlayer 12 was measured using spectroscopic ellipsometry (ESM300, manufactured by J. A. Woollam Co.).

Preparation of Surface Layer

The surface layer 13 of the present disclosure made of the material 1 for forming a surface layer was formed on the underlayer 12 by a vapor deposition method using the vacuum deposition apparatus (dome diameter 1900 mm, deposition distance 890 mm) to prepare an optical member of Example 1. The thickness of the surface layer 13 measured using a spectroscopic ellipsometry (ESM300, manufactured by J. A. Woollam Co.) was 10 nm. Further, the composition ratio of component B to component A in the obtained surface layer that was measured with a micro-Raman spectrometer was 0.20, which was the same as the mass ratio of component B to component A in the material for forming a surface layer.

The configuration of the obtained optical member is the same as the configuration of the optical member having the surface layer of the present disclosure shown in FIG. 1.

Evaluation of Frictional Force

For the surface layer of the prepared optical member, the frictional force of the surface layer was measured according to the following method.

An automatic friction and wear analyzer Triboster 500 manufactured by Kyowa Interface Science Co., Ltd. was used as a frictional force measurement device. A rubber pad (lens blocking pad manufactured by 3M) cut to 2 mm² was used as a contactor for measuring the frictional force, and the frictional force was measured by bringing the rubber pad into contact with the surface layer of the optical member. At this time, the test was conducted by adjusting the applied load of the device so that the loads applied to the surface layer were 14 kgf and 70 kgf. The measurement was implemented at a friction speed of 2.5 mm/sec. Table 6 shows the results.

Evaluation of Antifouling Characteristic

The antifouling characteristic of the surface layer of the prepared optical member were evaluated according to the following method.

As indexes showing the antifouling characteristic, the degree of repelling and ease of wiping off the ink of a highlighter pen were used as evaluation indexes, and evaluation was performed on the basis of the following criteria. Tables 6-1 and 6-2 show the results.

### Evaluation Criteria

A: When the pen tip is applied to the surface layer, the ink is repelled in less than 2 sec into a spherical shape and can be easily wiped off with clint paper.
B: After applying the pen tip to the surface layer, the ink is repelled over 2-5 sec into a spherical shape and can be wiped off with clint paper.
C: After applying the pen tip to the surface layer, the ink is not repelled even after 5 sec and cannot be wiped off unless strongly rubbed with clint paper.

### Examples 2 to 198

Materials for forming a surface layer were prepared by compounding in a metal container and then underlayers and surface layers were formed and optical members having surface layers of the present disclosure were prepared in the same manner as in Example 1, except that the compounds listed in Table 2 and used as component A, the compounds listed in Table 4 and used as component B, and the composition ratio of component B to component A after forming the surface layer were changed as shown in Tables 6-1, 6-2 and Tables 7-1, 7-2, 7-3 and 7-4, respectively.

In addition, evaluation of frictional force and evaluation of antifouling performance were performed in the same manner as in Example 1. Tables 6-1, 6-2 and 7-1, 7-2, 7-3 and 7-4 show the results.

In Examples 2 to 198, similarly to Example 1, the composition ratio of component B to component A in the obtained surface layer coincided with the mass ratio of component B to component A in the material for forming a surface layer.

TABLE 6-1

| | Combination of | | Evaluation of frictional | | | |
|---|---|---|---|---|---|---|
| | compounds of | Component A: | force | | | |
| | component A | Component B | | | Rate of | |
| Example | and component | (composition | 14 | 70 | change | Antifouling |
| No. | B | ratio) | kgf | kgf | [%] | characteristic |
| Example 1 | B-19 × a-4 | 1:0.20 | 53 | 112 | 110 | A |
| Example 2 | | 1:0.33 | 100 | 210 | 110 | A |
| Example 3 | | 1:0.55 | 214 | 449 | 110 | A |
| Example 4 | | 1:0.15 | 8 | 62 | 675 | A |
| Example 5 | | 1:0.25 | 43 | 154 | 258 | A |
| Example 6 | | 1:0.38 | 92 | 203 | 121 | A |
| Example 7 | | 1:0.75 | 276 | 455 | 65 | A |
| Example 8 | B-19 × a-3 | 1:0.20 | 22 | 96 | 336 | A |
| Example 9 | | 1:0.33 | 82 | 167 | 104 | A |
| Example 10 | B-19 × a-6 | 1:0.20 | 37 | 111 | 200 | A |
| Example 11 | | 1:0.33 | 101 | 235 | 133 | A |
| Example 12 | B-19 × a-7 | 1:0.20 | 52 | 110 | 112 | A |
| Example 13 | | 1:0.33 | 72 | 125 | 74 | A |
| Example 14 | B-19 × a-8 | 1:0.20 | 45 | 140 | 211 | A |
| Example 15 | | 1:0.33 | 68 | 155 | 128 | A |
| Example 16 | B-19 × a-9 | 1:0.20 | 67 | 135 | 101 | A |
| Example 17 | | 1:0.33 | 74 | 162 | 119 | A |
| Example 18 | B-19 × a-10 | 1:0.20 | 60 | 152 | 153 | A |
| Example 19 | | 1:0.33 | 80 | 195 | 144 | A |
| Example 20 | B-19 × b-3 | 1:0.20 | 32 | 136 | 325 | A |
| Example 21 | | 1:0.33 | 45 | 155 | 244 | A |
| Example 22 | B-19 × b-4 | 1:0.20 | 30 | 150 | 400 | A |
| Example 23 | | 1:0.33 | 75 | 198 | 164 | A |
| Example 24 | B-19 × b-5 | 1:0.20 | 39 | 147 | 277 | A |
| Example 25 | | 1:0.33 | 46 | 158 | 243 | A |
| Example 26 | B-19 × b-6 | 1:0.20 | 30 | 150 | 400 | A |
| Example 27 | | 1:0.33 | 75 | 167 | 123 | A |
| Example 28 | B-19 × c-2 | 1:0.20 | 27 | 102 | 278 | A |
| Example 29 | | 1:0.33 | 56 | 142 | 154 | A |
| Example 30 | B-19 × d-1 | 1:0.20 | 37 | 105 | 184 | A |
| Example 31 | | 1:0.33 | 88 | 184 | 109 | A |
| Example 32 | B-19 × d-2 | 1:0.20 | 54 | 126 | 133 | A |
| Example 33 | | 1:0.33 | 102 | 195 | 91 | A |

TABLE 6-2

| | Combination of | | Evaluation of frictional | | | |
|---|---|---|---|---|---|---|
| | compounds of | Component A: | force | | | |
| | component A | Component B | | | Rate of | |
| Example | and component | (composition | 14 | 70 | change | Antifouling |
| No. | B | ratio) | kgf | kgf | [%] | characteristic |
| Example 34 | B-19 × d-3 | 1:0.20 | 57 | 113 | 98 | A |
| Example 35 | | 1:0.33 | 68 | 136 | 100 | A |
| Example 36 | B-19 × d-4 | 1:0.20 | 77 | 162 | 110 | A |
| Example 37 | | 1:0.33 | 111 | 195 | 76 | A |
| Example 38 | B-15 × a-3 | 1:0.20 | 20 | 85 | 325 | A |
| Example 39 | | 1:0.33 | 66 | 174 | 164 | A |
| Example 40 | B-15 × a-4 | 1:0.20 | 32 | 98 | 206 | A |
| Example 41 | | 1:0.33 | 44 | 152 | 245 | A |
| Example 42 | B-15 × a-6 | 1:0.20 | 37 | 109 | 195 | A |
| Example 43 | | 1:0.33 | 78 | 185 | 137 | A |
| Example 44 | B-15 × a-8 | 1:0.20 | 55 | 154 | 180 | A |
| Example 45 | | 1:0.33 | 69 | 178 | 158 | A |
| Example 46 | B-15 × b-3 | 1:0.20 | 26 | 80 | 208 | A |
| Example 47 | | 1:0.33 | 37 | 103 | 178 | A |
| Example 48 | B-15 × b-6 | 1:0.20 | 38 | 115 | 203 | A |
| Example 49 | | 1:0.33 | 57 | 154 | 170 | A |
| Example 50 | B-15 × d-1 | 1:0.20 | 66 | 178 | 170 | A |
| Example 51 | | 1:0.33 | 89 | 182 | 104 | A |
| Example 52 | B-15 × d-4 | 1:0.20 | 40 | 102 | 155 | A |
| Example 53 | | 1:0.33 | 66 | 135 | 105 | A |
| Example 54 | B-16 × a-3 | 1:0.20 | 12 | 76 | 533 | A |
| Example 55 | | 1:0.33 | 37 | 123 | 232 | A |
| Example 56 | B-16 × a-4 | 1:0.20 | 18 | 122 | 578 | A |
| Example 57 | | 1:0.33 | 50 | 147 | 194 | A |
| Example 58 | B-16 × a-6 | 1:0.20 | 27 | 111 | 311 | A |
| Example 59 | | 1:0.33 | 78 | 208 | 167 | A |
| Example 60 | B-16 × a-8 | 1:0.20 | 58 | 162 | 179 | A |
| Example 61 | | 1:0.33 | 88 | 197 | 124 | A |
| Example 62 | B-16 × b-3 | 1:0.20 | 23 | 88 | 283 | A |
| Example 63 | | 1:0.33 | 35 | 102 | 191 | A |
| Example 64 | B-16 × b-4 | 1:0.20 | 24 | 137 | 471 | A |
| Example 65 | | 1:0.33 | 62 | 198 | 219 | A |

TABLE 7-1

| | Combination of | | Evaluation of frictional | | | |
|---|---|---|---|---|---|---|
| | compounds of | Component A: | force | | | |
| | component A | Component B | | | Rate of | |
| Example | and component | (composition | 14 | 70 | change | Antifouling |
| No. | B | ratio) | kgf | kgf | [%] | characteristic |
| Example 66 | A-1 × a-1 | 1:0.20 | 297 | 447 | 51 | A |
| Example 67 | A-1 × a-4 | | 280 | 478 | 71 | A |
| Example 68 | A-1 × a-7 | | 276 | 499 | 81 | A |
| Example 69 | A-1 × b-1 | | 287 | 452 | 57 | A |
| Example 70 | A-1 × c-1 | | 265 | 435 | 64 | A |
| Example 71 | A-1 × d-3 | | 268 | 463 | 73 | A |
| Example 72 | A-2 × a-2 | | 278 | 482 | 73 | A |
| Example 73 | A-3 × a-2 | | 280 | 470 | 68 | A |
| Example 74 | A-4 × a-6 | | 263 | 452 | 72 | A |
| Example 75 | A-5 × a-2 | | 301 | 483 | 60 | A |
| Example 76 | A-6 × a-2 | | 297 | 467 | 57 | A |
| Example 77 | A-7 × a-6 | | 283 | 472 | 67 | A |
| Example 78 | A-8 × a-6 | | 308 | 469 | 52 | A |
| Example 79 | A-9 × a-6 | | 312 | 490 | 57 | A |
| Example 80 | A-10 × a-13 | | 298 | 463 | 55 | A |
| Example 81 | B-1 × a-2 | | 47 | 92 | 96 | A |
| Example 82 | B-1 × a-4 | | 55 | 115 | 109 | A |
| Example 83 | B-2 × a-2 | | 52 | 108 | 108 | A |
| Example 84 | B-2 × a-4 | | 57 | 124 | 118 | A |
| Example 85 | B-3 × a-2 | | 49 | 115 | 135 | A |
| Example 86 | B-3 × a-4 | | 55 | 137 | 149 | A |
| Example 87 | B-4 × a-2 | | 51 | 103 | 102 | A |
| Example 88 | B-5 × a-2 | | 49 | 98 | 100 | A |
| Example 89 | B-6 × a-2 | | 52 | 104 | 100 | A |
| Example 90 | B-7 × a-2 | | 55 | 114 | 107 | A |
| Example 91 | B-8 × a-2 | | 56 | 107 | 91 | A |
| Example 92 | B-9 × a-2 | | 47 | 115 | 145 | A |
| Example 93 | B-10 × a-2 | | 44 | 124 | 182 | A |
| Example 94 | B-11 × a-2 | | 46 | 132 | 187 | A |
| Example 95 | B-11 × b-4 | | 46 | 132 | 187 | A |
| Example 96 | B-12 × a-2 | | 43 | 156 | 263 | A |
| Example 97 | B-13 × a-2 | | 37 | 150 | 305 | A |
| Example 98 | B-13 × a-4 | | 43 | 148 | 244 | A |
| Example 99 | B-13 × b-3 | | 32 | 138 | 331 | A |

TABLE 7-2

| | Combination of | | Evaluation of frictional | | | |
|---|---|---|---|---|---|---|
| | compounds of | Component A: | force | | | |
| | component A | Component B | | | Rate of | |
| Example | and component | (composition | 14 | 70 | change | Antifouling |
| No. | B | ratio) | kgf | kgf | [%] | characteristic |
| Example 100 | B-13 × b-6 | 1:0.20 | 47 | 171 | 264 | A |
| Example 101 | B-13 × d-1 | | 67 | 143 | 113 | A |
| Example 102 | B-13 × d-4 | | 59 | 139 | 136 | A |
| Example 103 | B-14 × b-3 | | 38 | 164 | 332 | A |
| Example 104 | B-17 × b-3 | | 40 | 172 | 330 | A |
| Example 105 | B-18 × b-3 | | 28 | 162 | 479 | A |
| Example 106 | B-20 × a-3 | | 39 | 137 | 251 | A |
| Example 107 | B-20 × a-4 | | 55 | 161 | 193 | A |
| Example 108 | B-21 × a-3 | | 38 | 141 | 271 | A |
| Example 109 | B-21 × a-4 | | 52 | 159 | 206 | A |
| Example 110 | B-22 × c-1 | | 37 | 129 | 249 | A |
| Example 111 | B-23 × c-2 | | 36 | 134 | 272 | A |
| Example 112 | B-24 × a-4 | | 49 | 144 | 194 | A |
| Example 113 | B-24 × b-3 | | 37 | 111 | 200 | A |
| Example 114 | B-25 × a-4 | | 47 | 162 | 245 | A |
| Example 115 | B-25 × b-3 | | 33 | 139 | 321 | A |
| Example 116 | B-25 × b-5 | | 33 | 139 | 321 | A |
| Example 117 | B-26 × a-8 | | 41 | 158 | 285 | A |
| Example 118 | B-26 × b-3 | | 36 | 141 | 292 | A |
| Example 119 | B-27 × b-3 | | 31 | 148 | 377 | A |
| Example 120 | B-27 × b-4 | | 39 | 159 | 308 | A |
| Example 121 | B-28 × a-12 | | 44 | 163 | 270 | A |
| Example 122 | B-28 × b-3 | | 37 | 147 | 297 | A |
| Example 123 | B-29 × a-13 | | 49 | 155 | 216 | A |
| Example 124 | B-29 × b-3 | | 34 | 134 | 294 | A |
| Example 125 | B-30 × a-11 | | 87 | 163 | 87 | A |
| Example 126 | B-30 × b-3 | | 33 | 153 | 364 | A |
| Example 127 | B-31 × a-3 | | 22 | 134 | 509 | A |
| Example 128 | B-31 × a-4 | | 24 | 159 | 563 | A |
| Example 129 | B-31 × a-7 | | 42 | 147 | 250 | A |
| Example 130 | B-31 × a-8 | | 39 | 168 | 331 | A |
| Example 131 | B-31 × b-5 | | 41 | 146 | 256 | A |
| Example 132 | B-31 × b-6 | | 40 | 172 | 330 | A |

TABLE 7-3

| | Combination of | | Evaluation of frictional | | | |
|---|---|---|---|---|---|---|
| | compounds of | Component A: | force | | | |
| | component A | Component B | | | Rate of | |
| Example | and component | (composition | 14 | 70 | change | Antifouling |
| No. | B | ratio) | kgf | kgf | [%] | characteristic |
| Example 133 | B-31 × d-1 | 1:0.20 | 77 | 178 | 131 | A |
| Example 134 | B-31 × d-4 | | 78 | 165 | 112 | A |
| Example 135 | B-32 × a-11 | | 78 | 158 | 103 | A |
| Example 136 | B-33 × a-3 | | 37 | 124 | 235 | A |
| Example 137 | B-33 × a-4 | | 38 | 159 | 318 | A |
| Example 138 | B-33 × a-8 | | 34 | 130 | 282 | A |
| Example 139 | B-33 × a-8 | | 36 | 162 | 350 | A |
| Example 140 | B-33 × b-5 | | 37 | 109 | 195 | A |
| Example 141 | B-33 × b-6 | | 36 | 172 | 378 | A |
| Example 142 | B-33 × d-1 | | 72 | 158 | 119 | A |
| Example 143 | B-33 × d-4 | | 74 | 154 | 108 | A |
| Example 144 | B-34 × a-13 | | 66 | 132 | 100 | A |
| Example 145 | B-35 × a-3 | | 29 | 116 | 300 | A |
| Example 146 | B-35 × a-4 | | 31 | 166 | 435 | A |
| Example 147 | B-35 × a-7 | | 26 | 117 | 350 | A |
| Example 148 | B-35 × a-8 | | 33 | 158 | 379 | A |
| Example 149 | B-35 × b-5 | | 29 | 120 | 314 | A |
| Example 150 | B-35 × b-6 | | 30 | 172 | 473 | A |
| Example 151 | B-35 × d-1 | | 84 | 175 | 108 | A |
| Example 152 | B-35 × d-4 | | 82 | 169 | 106 | A |
| Example 153 | B-36 × a-13 | | 41 | 137 | 234 | A |
| Example 154 | B-37 × a-13 | | 43 | 136 | 216 | A |
| Example 155 | B-38 × a-13 | | 37 | 134 | 262 | A |
| Example 156 | B-39 × a-13 | | 39 | 129 | 231 | A |
| Example 157 | B-40 × a-13 | | 32 | 128 | 300 | A |
| Example 158 | B-41 × a-14 | | 29 | 131 | 352 | A |
| Example 159 | B-42 × a-7 | | 24 | 111 | 363 | A |
| Example 160 | B-42 × a-8 | | 28 | 163 | 482 | A |
| Example 161 | B-42 × a-11 | | 23 | 156 | 578 | A |
| Example 162 | B-42 × a-12 | | 30 | 120 | 300 | A |
| Example 163 | B-42 × b-5 | | 27 | 112 | 315 | A |
| Example 164 | B-42 × b-6 | | 31 | 170 | 448 | A |
| Example 165 | B-42 × d-1 | | 85 | 167 | 96 | A |
| Example 166 | B-42 × d-4 | | 83 | 158 | 90 | A |

TABLE 7-4

| | Combination of | | Evaluation of frictional | | | |
|---|---|---|---|---|---|---|
| | compounds of | Component A: | force | | | |
| | component A | Component B | | | Rate of | |
| Example | and component | (composition | 14 | 70 | change | Antifouling |
| No. | B | ratio) | kgf | kgf | [%] | characteristic |
| Example 167 | B-43 × a-7 | 1:0.20 | 22 | 132 | 500 | A |
| Example 168 | B-43 × a-8 | | 27 | 165 | 511 | A |
| Example 169 | B-43 × a-11 | | 25 | 135 | 440 | A |
| Example 170 | B-43 × a-12 | | 31 | 163 | 426 | A |
| Example 171 | B-43 × b-5 | | 26 | 132 | 408 | A |
| Example 172 | B-43 × b-6 | | 33 | 159 | 382 | A |
| Example 173 | B-43 × d-1 | | 87 | 168 | 93 | A |
| Example 174 | B-43 × d-4 | | 85 | 169 | 99 | A |
| Example 175 | B-44 × a-14 | | 29 | 140 | 383 | A |
| Example 176 | B-45 × a-7 | | 24 | 137 | 471 | A |
| Example 177 | B-45 × a-8 | | 29 | 156 | 438 | A |
| Example 178 | B-45 × a-11 | | 27 | 136 | 404 | A |
| Example 179 | B-45 × a-12 | | 30 | 161 | 437 | A |
| Example 180 | B-45 × a-14 | | 23 | 136 | 491 | A |
| Example 181 | B-45 × b-5 | | 24 | 129 | 438 | A |
| Example 182 | B-45 × b-6 | | 28 | 159 | 468 | A |
| Example 183 | B-45 × d-1 | | 87 | 173 | 99 | A |
| Example 184 | B-45 × d-4 | | 85 | 169 | 99 | A |
| Example 185 | C-1 × a-1 | | 268 | 445 | 66 | A |
| Example 186 | C-1 × a-4 | | 278 | 477 | 72 | A |
| Example 187 | C-1 × b-3 | | 264 | 447 | 69 | A |
| Example 188 | C-1 × b-4 | | 280 | 480 | 71 | A |
| Example 189 | C-1 × c-1 | | 276 | 445 | 61 | A |
| Example 190 | C-1 × d-3 | | 285 | 450 | 58 | A |
| Example 191 | C-2 × b-4 | | 290 | 467 | 61 | A |
| Example 192 | C-3 × b-4 | | 312 | 487 | 56 | A |
| Example 193 | D-1 × a-1 | | 98 | 166 | 69 | A |
| Example 194 | D-1 × a-4 | | 104 | 195 | 88 | A |
| Example 195 | D-1 × b-3 | | 97 | 165 | 70 | A |
| Example 196 | D-1 × b-4 | | 107 | 201 | 88 | A |
| Example 197 | D-1 × d-1 | | 124 | 196 | 58 | A |
| Example 198 | D-1 × d-4 | | 117 | 194 | 66 | A |

### Comparative Example 1

Only the compound (B-19) listed in Table 2 was injected into a metal container to prepare a material for forming a surface layer, and then an underlayer and a surface layer were formed in the same manner as in Example 1 to prepare an optical member. In addition, evaluation of frictional force and evaluation of antifouling performance were performed in the same manner as in Example 1. Table 8 shows the results.

### Comparative Example 2

Only the compound (B-15) listed in Table 2 was injected into a metal container to prepare a material for forming a surface layer, and then an underlayer and a surface layer were formed in the same manner as in Example 1 to prepare an optical member. In addition, evaluation of frictional force and evaluation of antifouling performance were performed in the same manner as in Example 1. Table 8 shows the results.

### Comparative Example 3

Only the compound (B-16) listed in Table 2 was injected into a metal container to prepare a surface layer forming material, and then an underlayer and a surface layer were formed in the same manner as in Example 1 to obtain an optical member. In addition, evaluation of frictional force and evaluation of antifouling performance were performed in the same manner as in Example 1. Table 8 shows the results.

### Comparative Example 4

Only the compound (a-4) listed in Table 4 was injected into a metal container to prepare a surface layer forming material, and then an underlayer and a surface layer were formed in the same manner as in Example 1 to obtain an optical member. In addition, evaluation of frictional force and evaluation of antifouling performance were performed in the same manner as in Example 1. Table 8 shows the results.

### Comparative Examples 5 to 16

The underlayers and surface layers were formed, and the optical members were prepared in the same manner as in Example 1, except that the compounds listed in Table 2 and used as component A, the compounds listed in Table 4 or Table 9 and used as component B, and the composition ratio of component A and component B after forming the surface layer were changed as shown in Table 8.

In Table 8, (d-5), (d-6), (d-7), and (d-8) indicate compounds having the structures shown in Table 9. In addition, evaluation of frictional force and evaluation of antifouling performance were performed in the same manner as in Example 1. Table 8 shows the results. In Comparative Examples 5 to 16, similarly to Example 1, the composition ratio of component B to component A in the obtained surface layer coincided with the mass ratio of component B to component A in the material for forming a surface layer.

TABLE 8

| | Combination of | | Evaluation of frictional | | | |
|---|---|---|---|---|---|---|
| | compounds of | Component A: | force | | | |
| | component A | Component B | | | Rate of | |
| Example | and component | (composition | 14 | 70 | change | Antifouling |
| No. | B | ratio) | kgf | kgf | [%] | characteristic |
| Comparative Example 1 | only B-19 | — | 32 | 29 | −9 | A |
| Comparative Example 2 | only B-15 | — | 35 | 30 | −14 | A |
| Comparative Example 3 | only B-16 | — | 35 | 32 | −9 | A |
| Comparative Example 4 | only a-4 | — | O.L. | O.L. | — | C |
| Comparative Example 5 | B-19 × a-4 | 1:0.07 | 36 | 30 | −17 | A |
| Comparative Example 6 | | 1:0.13 | 77 | 82 | 6 | A |
| Comparative Example 7 | | 1:0.10 | 42 | 52 | 24 | A |
| Comparative Example 8 | | 1:1.00 | 431 | 551 | 28 | B |
| Comparative Example 9 | B-19 × d-5 | 1:0.20 | 32 | 31 | −3 | A |
| Comparative Example 10 | | 1:0.33 | 32 | 31 | −3 | A |
| Comparative Example 11 | B-19 × d-6 | 1:0.20 | 45 | 62 | 38 | A |
| Comparative Example 12 | | 1:0.33 | 60 | 78 | 30 | A |
| Comparative Example 13 | B-19 × d-7 | 1:0.20 | 32 | 31 | −3 | A |
| Comparative Example 14 | | 1:0.33 | 48 | 65 | 35 | A |
| Comparative Example 15 | B-19 × d-8 | 1:0.20 | 45 | 62 | 38 | A |
| Comparative Example 16 | | 1:0.33 | 50 | 70 | 40 | A |

In Table 8, O. L. indicates that the frictional force could not be measured due to overload.

TABLE 9

| No. | Structure |
|---|---|
| d-5 | H—[CH₂]₇₀—H |
| d-6 | H—[CH₂]₁₄₀—H |
| d-7 | (MeO)₃—Si—[CH₂]₃₂—H |
| d-8 | (MeO)₃—Si—[CH₂]₇₀—H |

### Example 199

The optical member (glass lens) obtained in Example 2 was processed and mounted on a commercially available frame to produce eyeglasses. When the antifouling performance was evaluated in the same manner as in Example 1, the evaluation result was “A”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A surface layer comprising at least a component A and a component B, wherein
the component A has an organic segment comprising fluorine,
the component B has an organic segment having at least one bond selected from the group consisting of an unsaturated hydrocarbon bond, a carbon-oxygen double bond and a carbon-nitrogen double bond,
a composition ratio of component B to component A in the surface layer is from 0.15 to 0.80,
the component B is an alkyl compound having a structure represented by a following general formula
R₃—Y—R₄ (2),
a segment represented by the Y has one or more segments having at least one bond selected from the group consisting of [CᵢH₂ᵢ₋₂]ⱼ₁, [CᵢH₂ᵢ]ⱼ₃, [CᵢH₃ᵢ]ⱼ₄ and [C₆H₄]ⱼ₅,
the i, j₁, j₃, j₄ and j₅ satisfy 32≤i×(j₁+j₃+j₄+j₅)≤180,
the j₁, j₃, j₄ and j₅ are each independently an integer of 0 or more,
the i is an integer of 1 or more independently for each of the segments, and
the R₃ and the R₄ are each independently a hydrolyzable silyl group, a hydroxyl group or a hydrogen atom.

2. The surface layer according to claim 1, wherein the organic segment comprising fluorine is at least one segment selected from the group consisting of a fluoroalkyl segment, a fluoroalkyl ether segment, a fluoropolyether segment, a vinylidene fluoride segment and a perfluoropolyether segment.

3. The surface layer according to claim 1, wherein
the component A is a compound having a structure represented by a following general formula
R₁—X—R₂ (1),
a segment represented by the X consists of any combination of at least one segment selected from [CₙH₂ₙ]ₘ₁, [CₙF₂ₙ]ₘ₂, [CₙHₙFₙ]ₘ₃, [CₙH₂ₙ]ₘ₄O, [CₙF₂ₙ]ₘ₅O, [CₙHₙFₙ]ₘ₆O, [CₙH₂ₙO]ₘ₇, [CₙF₂ₙO]ₘ₈, [CₙHₙFₙO]ₘ₉, [CₙH₂ₙOₙ]ₘ₁₀, [CₙF₂ₙOₙ]ₘ₁₁, [CₙHₙFₙOₙ]ₘ₁₂O, [C₆H₄]ₘ₁₃, [CH₃]ₘ₁₄, O[CH₃]ₘ₁₅, [CF₃]ₘ₁₆ and O[CF₃]ₘ₁₇,
the n, m₁, m₂, m₃, m₄, m₅, m₆, m₇, m₈, m₉, m₁₀, m₁₁, m₁₂, m₁₃, m₁₄, m₁₅, m₁₆, and m₁₇ satisfy 15≤n×(m₁+m₂+m₃+m₄+m₅+m₆+m₇+m₈+m₉+m₁₀+m₁₁+m₁₂+m₁₃+m₁₄+m₁₅+m₁₆+m₁₇)≤200,
the m₁, m₂, m₃, m₄, m₅, m₆, m₇, m₈, m₉, m₁₀, m₁₁, m₁₂, m₁₃, m₁₄, m₁₅, m₁₆, and m₁₇ are each independently an integer of 0 or more,
the n is an integer of from 1 to 6 independently for each of the segments,
the R₁ is an organic group containing a hydrolyzable group, a silanol group, or a hydrolyzable group-containing silyl group, and
the R₂ is a hydrogen- or fluorine-terminated alkyl segment or alkyl ether segment.

4. The surface layer according to claim 1, wherein
the component B has an organic segment having an unsaturated hydrocarbon bond, and
the unsaturated hydrocarbon bond is derived from at least one compound selected from the group consisting of 1,2-polybutadiene, 1,4-polybutadiene, 1,2-polyisoprene, 1,4-polyisoprene, 1,2-polychloroprene and 1,4-polychloroprene.

5. The surface layer according to claim 1, wherein
the component B has a polyolefin having, in a side chain, an organic segment having at least one bond selected from the group consisting of an unsaturated hydrocarbon bond, a carbon-oxygen double bond and a carbon-nitrogen double bond.

6. The surface layer according to claim 1, wherein
the component A has a perfluoropolyether segment,
the component B has an organic segment having an unsaturated hydrocarbon bond, and
the unsaturated hydrocarbon bond is derived from at least one compound selected from the group consisting of 1,2-polybutadiene and 1,2-polyisoprene.

7. An optical member comprising the surface layer according to claim 1.

8. Eyeglasses comprising the optical member according to claim 7.

9. A material for forming a surface layer, comprising at least a component A and a component B, wherein
the component A has an organic segment comprising at least fluorine,
the component B has an organic segment having at least one bond selected from the group consisting of an unsaturated hydrocarbon bond, a carbon-oxygen double bond and a carbon-nitrogen double bond, and
the mass ratio of component B to component A in the material for forming the surface layer is from 0.15 to 0.80,
the component B is an alkyl compound having a structure represented by a following general formula
R₃—Y—R₄ (2),
a segment represented by the Y comprises one or more segments having at least one bond selected from the group consisting of [CᵢH₂ᵢ₋₂]ⱼ₁, [CᵢH₂ᵢ]ⱼ₃, [CᵢH₃ᵢ]ⱼ₄ and [C₆H₄]ⱼ₅,
the i, j₁, j₃, j₄ and j₅ satisfy 32≤i×(j₁+j₃+j₄+j₅)≤180,
the j₁, j₃, j₄ and j₅ are each independently an integer of 0 or more,
the i is an integer of 1 or more independently for each of the segments, and
the R₃ and the R₄ are each independently a hydrolyzable silyl group, a hydroxyl group or a hydrogen atom.

10. The material for forming the surface layer according to claim 9, wherein the organic segment comprising fluorine is at least one segment selected from the group consisting of a fluoroalkyl segment, a fluoroalkyl ether segment, a fluoropolyether segment, a vinylidene fluoride segment and a perfluoropolyether segment.

11. The material for forming the surface layer according to claim 9, wherein
the component A is a compound having a structure represented by a following general formula
R₁—X—R₂ (1),
a segment represented by the X consists of any combination of at least one segment selected from [CₙH₂ₙ]ₘ₁, [CₙF₂ₙ]ₘ₂, [CₙHₙFₙ]ₘ₃, [CₙH₂ₙ]ₘ₄O, [CₙF₂ₙ]ₘ₅O, [CₙHₙFₙ]ₘ₆O, [CₙH₂ₙO]ₘ₇, [CₙF₂ₙO]ₘ₈, [CₙHₙFₙO]ₘ₉, [CₙH₂ₙOₙ]ₘ₁₀, [CₙF₂ₙOₙ]ₘ₁₁, [CₙHₙFₙOₙ]ₘ₁₂O, [C₆H₄]ₘ₁₃, [CH₃]ₘ₁₄, O[CH₃]ₘ₁₅, [CF₃]ₘ₁₆ and O[CF₃]ₘ₁₇,
the n, m₁, m₂, m₃, m₄, m₅, m₆, m₇, m₈, m₉, m₁₀, m₁₁, m₁₂, m₁₃, m₁₄, m₁₅, m₁₆, and m₁₇ satisfy 15≤n×(m₁+m₂+m₃+m₄+m₅+m₆+m₇+m₈+m₉+m₁₀+m₁₁+m₁₂+m₁₃+m₁₄+m₁₅+m₁₆+m₁₇)≤200,
the m₁, m₂, m₃, m₄, m₅, m₆, m₇, m₈, m₉, m₁₀, m₁₁, m₁₂, m₁₃, m₁₄, m₁₅, m₁₆, and m₁₇ are each independently an integer of 0 or more,
the n is an integer of from 1 to 6 independently for each of the segments,
the R₁ is an organic group containing a hydrolyzable group, a silanol group, or a hydrolyzable group-containing silyl group, and
the R₂ is a hydrogen- or fluorine-terminated alkyl segment or alkyl ether segment.

12. The material for forming the surface layer according to claim 9, wherein
the component B has an organic segment having an unsaturated hydrocarbon bond, and
the unsaturated hydrocarbon bond is derived from at least one compound selected from the group consisting of 1,2-polybutadiene, 1,4-polybutadiene, 1,2-polyisoprene, 1,4-polyisoprene, 1,2-polychloroprene and 1,4-polychloroprene.

13. The material for forming the surface layer according to claim 9, wherein
the component B has a polyolefin having, in a side chain, an organic segment having at least one bond selected from the group consisting of an unsaturated hydrocarbon bond, a carbon-oxygen double bond and a carbon-nitrogen double bond.

14. The material for forming the surface layer according to claim 9, wherein
the component A has a perfluoropolyether segment,
the component B has an organic segment having an unsaturated hydrocarbon bond, and
the unsaturated hydrocarbon bond is derived from at least one compound selected from the group consisting of 1,2-polybutadiene and 1,2-polyisoprene.

15. A surface layer formed of the material for forming the surface layer according to claim 9.

16. An optical member comprising the surface layer according to claim 15.

17. Eyeglasses comprising the optical member according to claim 16.
